(19) United States
(12) Patent Application Publication
(10) Pub. No.: US 2017/0177802 A1
(43) Pub. Date: Jun. 22, 2017

(54) Allergy Service Management Portal

(71) Applicant: Allergy Solutions, Inc., Erie, CO (US)

(72) Inventor: Neil Smith, Erie, CO (US)

(21) Appl. No.: 15/379,276

(22) Filed: Dec. 14, 2016

Related U.S. Application Data
(60) Provisional application No. 62/268,902, filed on Dec. 17, 2015.
(60) Provisional application No. 62/358,243, filed on Jul. 5, 2016.

(51) Int. Cl. G06F 19/00; G06F 17/30

(52) U.S. Cl. CPC G06F 19/325; G06F 19/321; G06F 17/3053

(57) ABSTRACT

Aspects of the present disclosure involve systems, programs, and methods for an allergy management system (AMS). In general, the AMS provides a system through which a practitioner or other user may manage allergy-related care for one or more patients. In one embodiment, the AMS includes an application executed on a computing device, such as a tablet or other type of mobile computing device, which provides an interface for the user to manage various information and/or algorithms to aid the practitioner in providing the allergy care. For example, the AMS provides an interface through which a user may enter information concerning allergy-related care of a patient and store such information in a database. Information concerning multiple patients may be similarly stored in the database from a particular practitioner or for multiple practitioners. Further, the information may be correlated across the practitioner's patients and/or every stored patient's information to obtain a patient population trends to aid the practitioner or the AMS in recommended responses to a particular patients symptoms. Further still, the AMS may receive measurement information of a skin wheal test of a patient from a scanner component of a computing device and utilize that measurement information to aid the practitioner in the patient care.

### CROSS-REFERENCE TO RELATED APPLICATIONS

This application claims the benefit under 35 U.S.C. § 119(e) of U.S. Provisional Patent Application No. 62/268,902, filed on Dec. 17, 2015, and entitled “Allergy Service Management Portal,” and U.S. Provisional Patent Application No. 62/358,243, filed Jul. 5, 2016, and entitled “Allergy Service Management Portal,” the contents of which are incorporated by reference as if fully disclosed herein.

### FIELD

Aspects of the present disclosure relate to medical services, among other functions, and more particularly to a system for automatic generation of allergy treatment recommendations and management of allergy-related medical services.

### BACKGROUND

The allergy epidemic in the United States is well documented. With approximately 60,000,000 allergy sufferers and an ever-shrinking number of allergists, the allergy-care burden typically falls to a primary care practitioner. Therefore, allergy care is one of many medical conditions that a primary care practitioner must address. As such, the primary care practitioner may lack the specific understanding and, more importantly, the infrastructure to adequately address the allergy-care needs of allergy sufferers. Thus, the level of allergy-care provided may vary wildly from practitioner to practitioner. Also, it is often difficult for a primary care practitioner to fit the specific needs of providing allergy-related care into pre-existing systems and/or procedures already utilized by the primary care practitioner. Rather, many primary care practitioners provide ad hoc solutions to provide allergy-related care that are inefficient and may reduce the quality of care provided to the patient.

It is with these and other issues in mind that various aspects of the present disclosure were developed.

### SUMMARY

Embodiments described herein generally reference a system for providing allergy-related care. The system may interface with a user computing device, such as a physician's computer terminal, in order to facilitate storage of patient information and provision of allergy care.

In some embodiments, a system for providing allergy-related care includes a database, a user computing device, an imaging device, and a network device executing an allergy management application. The allergy management application typically receives patient-related information from a user (such as a physician or a patient) through a portal executed on the user computing device and stores the patient-related information in the database. The allergy management application further receives a skin wheal image captured by the imaging device, and identifies an antigen based on the skin wheal image and the patient-related information.

Based on the identified antigen, the allergy management application determines a prescription recommendation and provides the prescription recommendation to the user computing device. In some examples, the allergy management application identifies a plurality of antigens based on the skin wheal image and the patient-related information and ranks the plurality of antigens from most relevant to least relevant. The ranking may be based on an allergenicity score and a seasonality of the antigens. In further examples the allergy management application analyzes the skin wheal image and bases the allergenicity score on the analysis.

In other embodiments, a method for providing allergy-related care includes receiving patient-related information from a user computing device, analyzing the patient-related information to determine an environmental antigen, and storing the patient-related information in a database. The method further calculates a prescription recommendation based on the determined environmental antigen and provides the calculated prescription recommendation to the user computing device.

In still other embodiments, an electronic device for providing allergy-related care includes a network interface coupled to a processor. The processor receives patient-related information from a portal device and identifies an antigen based on the patient-related information. The processor further stores the patient-related information in a database and calculates a prescription recommendation based on the identified antigen. The prescription recommendation is transmitted to the portal device, and the processor receives an approval of the prescription recommendation from the portal device.

### BRIEF DESCRIPTION OF THE DRAWINGS

Reference will now be made to representative embodiments illustrated in the accompanying figures. It should be understood that the following descriptions are not intended to limit the disclosure to one preferred embodiment. To the contrary, each is intended to cover alternatives, modifications, and equivalents as may be included within the spirit and scope of the described embodiments as defined by the appended claims.

FIG. 1 illustrates an example computing system for providing allergy-care related services through an allergy management portal, according to one embodiment.

FIG. 2 illustrates an example user interface displaying an allergy management portal, according to one embodiment.

FIG. 3 illustrates example operations for providing a medicine recommendation for a patient based on one or more allergy symptoms, according to one embodiment.

FIG. 4 shows an example computing system that may implement various systems and methods discussed herein, according to one embodiment.

FIGS. 5-8B illustrate example user interfaces for an example patient/physician portal according to various embodiments.

FIG. 9 illustrates a method for determining a prescription according to one embodiment.

### DETAILED DESCRIPTION

Aspects of the present disclosure involve systems, programs, and methods for an allergy management system (AMS). In general, the AMS provides a system through which a practitioner or other user may manage allergy-related care for one or more patients. In one embodiment, the AMS includes an allergy management application executed on a computing device, such as a tablet or other type of mobile computing device, which provides an interface for the user to manage various information and/or algorithms to aid the practitioner in providing the allergy care.

For example, the AMS provides an interface through which a user (e.g., a doctor or medical practitioner) may enter patient-related information concerning allergy-related care of a patient and store such information in a database. Information concerning multiple patients may be similarly stored in the database from a particular practitioner or for multiple practitioners. Further, the information may be correlated across the practitioner's patients and/or every stored patient's information to obtain a patient population trends to aid the practitioner or the AMS in recommended responses to a particular patients symptoms. In this manner, patient-related information (or simply patient information) may be obtained, stored, and categorized to better manage the patient's information and provide improved medicine/dosage recommendations. Further still, patients may be provided access to the AMS to receive updates, reminders, recommendations and the like based on the patient information stored in the database.

In another embodiment, the AMS communicates with one or more third party systems or programs to provide patient information and/or receive information from the third party system. For example, patient information may be provided to a billing program or company to properly bill the patient for the rendered services. In another example, prescriptions and patient information may be transmitted to a pharmacy or other electronic pharmaceutical companies such that the pharmacy may fill a patient's prescription needs. Further still, the AMS may communicate with Electronic Health Record (EHR) systems or other protocol-based systems for information gathering and storage. In general, any third party system or company in which a medical practitioner may communicate or provide patient information may communicate with the AMS directly over a network to streamline or improve the sharing of such information. Such transmission of information may be maintained by the AMS to comply with all regulations in place to ensure the privacy of the patient information without input from the practitioner or other system user.

In addition, the AMS may analyze information provided for a particular patient, some patients, or all patients to provide medicine and/or dosage information to treat the allergic reactions suffered by the patient. Such recommendations may compare the specific patient's symptoms to other patient's symptoms, success of previous medicine combinations in the particular patient and/or patient symptoms, the particular time of year or season of the recommendation, and/or the type and number of detected allergens in the patient's area. In this manner, the AMS may utilize a machine-learning functionality to continually monitor and improve medical and dosage recommendations for a patient's measured symptoms. In addition, a computing device through which the AMS is accessed may be utilized to determine one or more results from an allergy-skin-test. For example, a camera associated with the computing device may be utilized to obtain and determine a wheal size or other measurement of a patient during an allergy skin test.

In another embodiment, the AMS communicates wirelessly via Bluetooth technology (or any other suitable wired or wireless communication technology) with an allergy-drops-pump device, whereby each time a dose of allergy-drops therapy is dispensed, the AMS receives information from the allergy-drops-pump device that a dose has been administered. The AMS then stores the allergy-drops dose information for each unique patient, which can be compiled into a treatment compliance record for each patient individually, and can be compiled into a de-identified data report for the patient population of each physician or clinic and for the entire patient population enrolled in the allergy-treatment program or every patient represented in the AMS (and having provided appropriate permissions for use, monitoring, and/or analysis of their information).

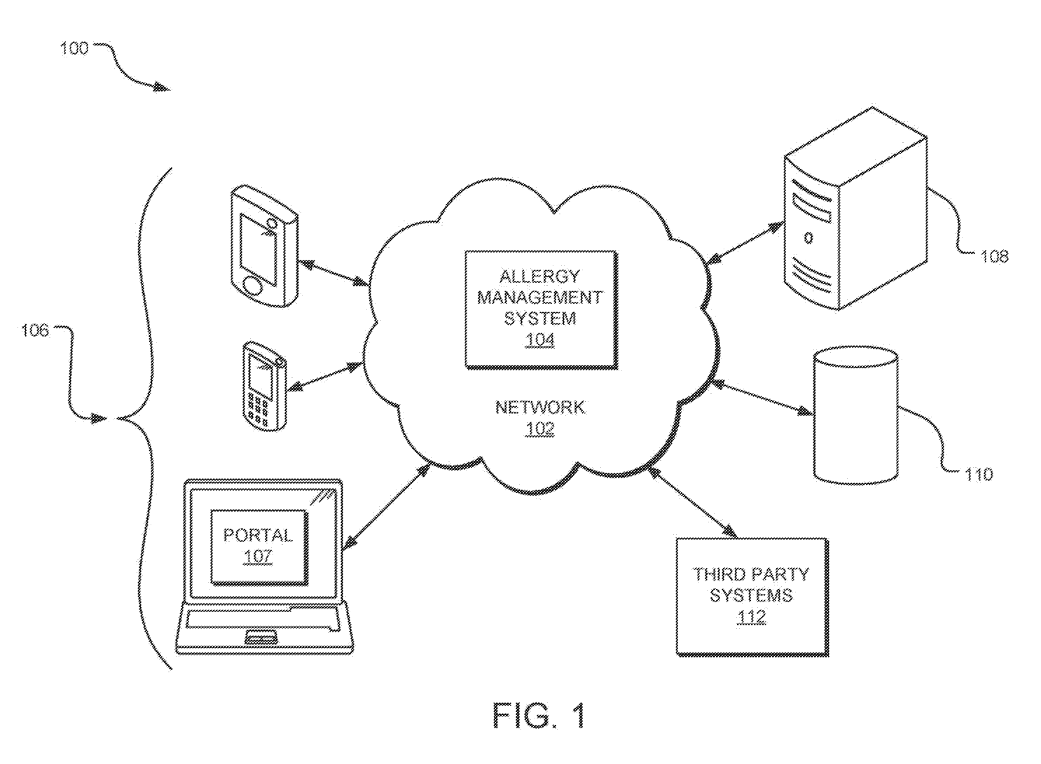

For a detailed description of an example system 100 for providing the AMS 104, reference is made to FIG. 1. As depicted in FIG. 1, a network 102, which may be, without limitation, the Internet, an Intranet, an Ethernet network, a wired network, a wireless network, or the like, is used by one or more computing and/or data storage devices 106 (e.g., one or more databases 110) for implementing the system 100.

In general, a portal 107 is an application or software program executed on a user computing device 106. The user computing device 106 is generally any form of computing device, such as a personal computer, work station, terminal, mobile computer, mobile device, smartphone, tablet, a multimedia console, or the like. The portal 107 provides an interface for a user to access an allergy management system (AMS) 104 executed or otherwise embodied on a network 102. In one embodiment, the AMS 104 is executed on one or more application servers 108 or other network devices of the network 102. Thus, at least one component or portion of the AMS 104 may be executed on the one or more application servers 108 and/or one or more portions may be executed on the user computing device 106 of the user.

In general, the application server 108 hosts the AMS 104. In one implementation, the server 108 also hosts a website or an application that users may visit to access components of the system 100, including the content compiler 104. The server 108 may be a single server, a plurality of servers with each such server being a physical server or a virtual machine, or a collection of both physical servers and virtual machines. In another implementation, a cloud hosts one or more components of the system 100. The user computing device 106, the server 108, and other resources connected to the network 102 may access one or more other servers to access one or more websites, applications, web services interfaces, storage devices, computing devices, etc. that are used to generate a framework for displaying a compiled content set for a particular project. The server 108 may also host a search engine that the content compiler 104 uses for accessing, searching for, and modifying content files.

The AMS 104 may also communicate with other systems utilizing the network 102. For example, the AMS 104 may communicate with one or more databases 110 available to access and store information via the network 102. For example, patient information received through the portal 107 may be stored in the database 110. The AMS 104 may also configure or otherwise manage the received information within the database, including storing the information with reference to a particular patient, with reference to a particular practitioner, with reference to a particular geographic area, or with reference to any other portion of the information that could be used to sort the received information. In addition, the database 110 may store information from any number of portals 107 connected to the network 102 such that information may be correlated or shared among the various portals and practitioners.

In addition, the AMS 104 may communicate with one or more third party systems 112 connected to or otherwise in communication with the network 102. For example, a third party system 112 may include a computing network associated with a pharmacy or other type of e-prescribing system. The AMS 104 provides information concerning a patient through the network 102 to the pharmacy system 112 for prescription filling and tracking for the patient. In another embodiment, the AMS 104 integrates with one or more electronic health record (EHR) or other electronic health form that a particular practitioner may utilize during operation of a health clinic. In one example, the AMS 104 may be an interface between the practitioner and the EHR system 112. In another example, the practitioner may utilize and enter information into the EHR 112 that is then provided to the AMS 104. In this example, the AMS 104 may convert the information entered into the EHR 112 and populate one or more fields of the AMS for further processing by the system. In another embodiment, the third party system 112 is a billing, collections, or other payment management program or company to receive and process payment information for one or more patients of a practitioner. In still another embodiment, the third party system 112 may be a training program or other multimedia program that is accessible through the AMS 104 for training and general information of the practitioner. The various third party systems 112 in communication with and accessible through the AMS 104 and the network 102 are discussed in greater detail below.

In general, the portal 107 executed on the user computing device 106 provides access to the AMS 104 to aid a practitioner in providing allergy-related care to one or more patients. For example, the AMS 104 may interact with the portal 107 (or other suitable systems or devices) to receive information in one or more data fields of the portal for the entry of allergy skin-prick and intradermal-test-wheal-size results by the allergy-test personnel. The AMS 104 may store such patient information in the database 110 associated with the network 102 on which the AMS is executed. Further, with such information, the AMS 104 may generate one or more allergy scores, with reporting capabilities on individual patients and collective patient populations' allergy-patient-symptom-score results, over specified time periods. Other informational reports may also be generated on client allergy program usage, such as on a weekly, monthly, annual, etc. basis and provided to a user of the portal 107 through a user interface. In addition to receiving and storing information and generating reports on such information, the AMS 104 may also provide a customized immunotherapy treatment for a patient using an algorithm, that factors in patient-skin-test results, seasonality of patient symptoms, seasonal patterns of antigens, antigenicity of antigens, cross-reactivity of antigens, and the like.

In addition, through communication over a network 102 with one or more third party systems 112, the AMS 104 may provide secure transmission of immunotherapy prescriptions to a compounding pharmacy (or any other type of pharmacy or provider), provide inventory management by tracking inventory levels based on allergy-test volume at the client clinic location, send re-order notification to the client-clinic once inventory levels reach the re-order volume, provide client billing and invoicing services that automatically invoices client-clinics each month, integrate with one or more EHR application program interfaces (APIs) making it easy for a client-clinic to use the portal without departing from their usual clinic-management system, and/or automatically calculate sales commissions to be paid to company sales representatives based on product utilization at each client-clinic site. In general, any third party system 112 utilized in the operation of a practitioner clinic or other allergy-related care may be accessed by the AMS 104 to provide services to a user of the portal 107. Various features and options available to a practitioner through the use of the portal 107 and the AMS 104 are discussed in more detail below.

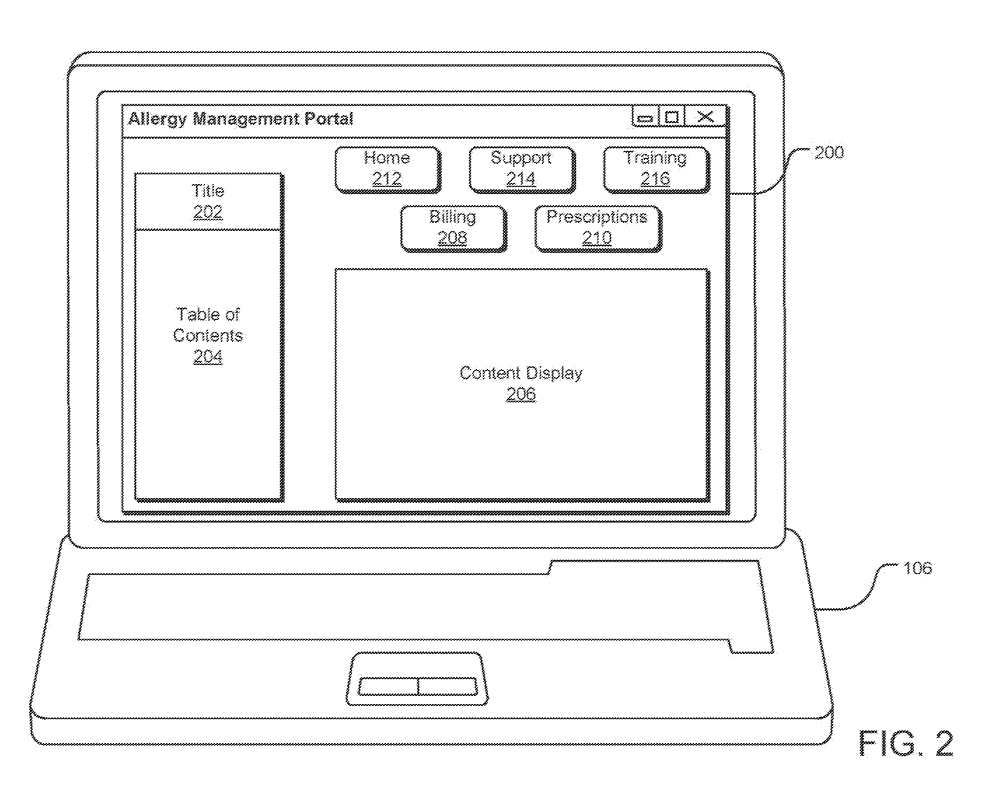

Turning to FIG. 2, an example user interface generated by the AMS 104 and illustrated in the portal 107 on the user computing device 106 is shown displaying one or more interactive portions for use by a user of the portal 107. In the implementation shown in FIG. 2, the portal 107 to the AMS 104 is a website or application executing on the computing device that includes information and services available through the portal 107. In particular, a user interface 200 is provided on a display of the computing device 106. The user interface 200 may include one or more portions that allow for interaction with the portal 107, the AMS 104, a third party system 112, and/or the services provided by the AMS. Thus, one portion of the interface 200 may include a title 202 of a service and a table of contents 204 of sub-services available through the portal 107. In one implementation, the table of contents 204 may provide headings and/or links for the various services and sub-services. Upon selection of one of the links in the table of contents 204, the service is presented in the content display 206, which may be displayed in the same window or one or more separate windows or tabs.

The user interface 200 may include one or more buttons or options for performing other operations associated with the AMS 104. For example, a “billing” button 208 may be selected to access a billing portion of the AMS 104, including access to a third party billing system. Similarly, a “prescription” button 210 may be selected to manage one or more allergy related prescriptions of a user of the computing device 106 or a particular patient of a clinic providing allergy care. A home button 212 may be included to navigate a user of the interface 200 to a home page where access to additional services may be available. A support button 214 and a training button 216 provide the user with available resources, including contact information for support that may provide assistance to the user. In one implementation, the buttons 212, 214, 216, and/or other buttons or features may be minimized to maximize the content display 206. In another implementation, the content display 206 may be maximized to cover the user interface 200. It should be appreciated that the user interface 200 layout and design illustrated in FIG. 2 is but one example of a user interface of the portal 107. Any other design and layout is also contemplated to provide access to the one or more features of the AMS 104 to a user of the system.

Through the AMS 104 executed on a server 108 (or other network device of a network 102) and the portal 107, the AMS 104 may provide various allergy-care related features to a user. In one example, the user of the AMS 104 may be a practitioner providing allergy-related care to a patient. In another example, the user of the AMS 104 may be a patient receiving the allergy-related care. Through the portal 107, the patient may receive appointment reminders, such as reminders for appointments for allergy shots and/or follow-up allergy drops. In particular, the patient may receive an update or other reminder on the computing device 106 executing the portal 107 that reminds the patient about the appointment. In another example, the portal 107 may provide a reminder of the dosage of one or more prescriptions, reminders to complete a portion of all of a sino-nasal outcome test (SNOT-20) form that aids the patient and practitioner in providing allergy-related care, and the like. Further, in one embodiment, the SNOT-20 form may be an electronic form that may be stored at the AMS 104 and provided to the user of the portal 107 to be filled in by the user. As such, the AMS 104 may store or otherwise maintain one or more SNOT-20 forms (or any other type of electronic form or questionnaire), including patient-specific forms that have been partially or fully completed.

In a similar manner, the AMS 104 may execute general data gathering and analysis of the gathered data on a patient-level, a practitioner-level, a group or area-level, for all users of the AMS, and the like. For example, the AMS 104 may receive and track SNOT-20 forms or other questionnaires for individual patients, for client patient populations, and/or entire AMS patient populations. Such information may be stored in a database 110 associated with the AMS 104 and analyzed or otherwise processed. For example, with the stored patient information, a general understanding of high levels of allergens in a particular area may be determined. Detected high levels of a particular type of allergen may be used by the AMS 104 in providing recommendations for dosage of medications and/or providing alerts to one or more users of the portal 107. The AMS 104 may also use this information to determine aspects of antigen use, such as the seasonality, timing, and geography of such use, as well as any reported successes of antigen use. In general, the AMS 104 may utilize the database 110 and any received information to crowd-source information related to the allergy-care for any size of a geography base.

Other information that may be received, tracked, and reported by the AMS 104 may include tracking of medication use for cost savings analysis. For example, the AMS 104 may flag particular patients who use allergy-related medications for a particular practitioner and suggest, via reduced medication use, for patients on immunotherapy to reduce the cost of the medication. Further, such recommendations may be performed for individual patients, clinic population, and/or the entire AMS 104 population. Tracking and reporting of patient utilization patterns of prescribed medicines over time may also be performed.

In another embodiment, the AMS 104 may communicate with a third party system 112 through a network 102. For example, the third party system 112 may be an online pharmacy or a server associated with a pharmacy. The AMS 104 may conduct e-prescribing (e.g., by directly communication with the pharmacy) based on patient information entered into the AMS 104 through the portal 107 by a practitioner. Further, the AMS 104 may provide reminders or alerts to patients using the portal 107 that a refill of a prescription will be needed soon and whether or not the patient is in compliance with the prescription. In particular, the AMS 104 and portal 107 may provide a daily dosage reminder for allergy drops, may provide reminders for an allergy shots appointment visit, a reminder for a patient to set an appointment, and/or a refill reminder for a prescription. The reminder may be provided via the portal, via a short message service and/or multimedia messaging service text message, email, etc., or via another type of communication. The AMS 104 may also provide automatic refill requests to the pharmacy system 112, as well as notifications to practitioners using the portal 107 that one or more patients may need a refill or are non-compliant with a prescription direction for use. In general, any information concerning a patient's prescription may be provided to a pharmacy system 112, a practitioner, or the patient through the use of the AMS 104.

Other third party systems 112 may also be in communication with the AMS 104. For example, one or more practitioners may utilize EHRs during the operation of the practitioner clinic. Many practitioners may prefer to use known EHRs, as the practitioner may be familiar with the EHR form. Thus, in one embodiment, the AMS 104 may be configured to integrate with one or more systems 112 that receive information entered into an EHR. Such integration allows the AMS 104 to send patient information entered into the EHR back and forth between the AMS 104, the portal 107, and the computing system that supports the EHR. For example, ICD-10 codes are often used in EHRs for coding diseases, signs, and symptoms of a patient. These codes may be integrated with the AMS 104 and tracked to flag patients with frequent allergy related systems. Once a patient is flagged, an alert may be sent to the patient or a practitioner through the portal 107 to suggest performing an allergy test on the patient for future allergy related care.

In another example, the AMS 104 may utilize information provided through the EHRs to report back to a clinic administrator certain statistics on the allergy-related care provided by the clinic. For example, a breakdown of the number of allergic patients per provider may be displayed in the portal 107 on the computing device 106. Other information, such as the number of allergy tests ordered and patient compliance with immunotherapy plans may also be provided. Alerts and/or other flags may be displayed in the portal 107 to alert an administrator of the statistics related to each provider in the clinic to aid the administrator in the operation of the clinic.

The AMS 104 may communicate with another third party system 112, such as one or more billing and collection systems. For example, office visits may be entered through the portal 107, processed by the AMS 104, and, in communication with the third party billing system 112, may be billed to the patient. To facilitate this, information provided through the portal 107 may be branded with client and/or clinic identification for proper billing. Further, the portal 107 and/or AMS 104 may be configured to collect funds from the patient via an auto-debit or other payment option, fees may be extracted from an AMS 104 account associated with the patient, automatic reminders may be sent to users of the portal to pay an overdue amount, automatic messages may be provided to patients for declined or expired payment cards. Other third party financial systems 112 may also be in communication with the AMS 104 or third party billing system, including banking services for deposit of revenue in a clinic account, setting up an automatic payment system for outstanding balances from a patient's bank account, and the like. In yet another example, the third party billing system 112 may communicate with an electronic pharmacy to automatically charge for refills on prescriptions, all set up through the portal 107 and/or through the AMS 104.

In another example, the AMS 104 may communicate with a third party invoicing system 112 to automatically generate one or more invoices based on information received by the AMS. For example, the AMS 104 may provide information to the invoicing system 112 to automatically create one or more invoices for prescriptions (e.g., for allergy drops, allergy shots, or the like), food allergy tests, test kits, or other supplies purchased through the invoicing system, and the like. Similarly, the third party system 112 may include one or more systems for supply chain management. Thus, through the AMS 104 and portal 107, a clinic or practitioner may receive reminders to re-order supplies, tracking of supply inventory levels, reminders to re-order supplies based on an inventory level, and/or automatically re-order supplies either based on an elapsed time since the last re-order or based on an inventory level.

In yet another embodiment, the third party system 112 in communication with the AMS 104 may be one or more training systems. For example, the system 112 may provide one or more staff training modules (videos, documents, manuals, etc.) that may be viewed or otherwise accessible via the portal 107 of the user device 106. The training modules may aid the clinic or practitioner in providing allergy-related care to a patient. Other embodiments include support features, such as a live chat feature with a live person to offer clinical guidance and support, a calendar feature to schedule provider-level consultations, and/or an email system for clients to securely email the AMS 104 with non-urgent questions or concerns. The above-described features are but some of the many options available to users of the AMS 104 through the portal 107 executed on the user's device 106.

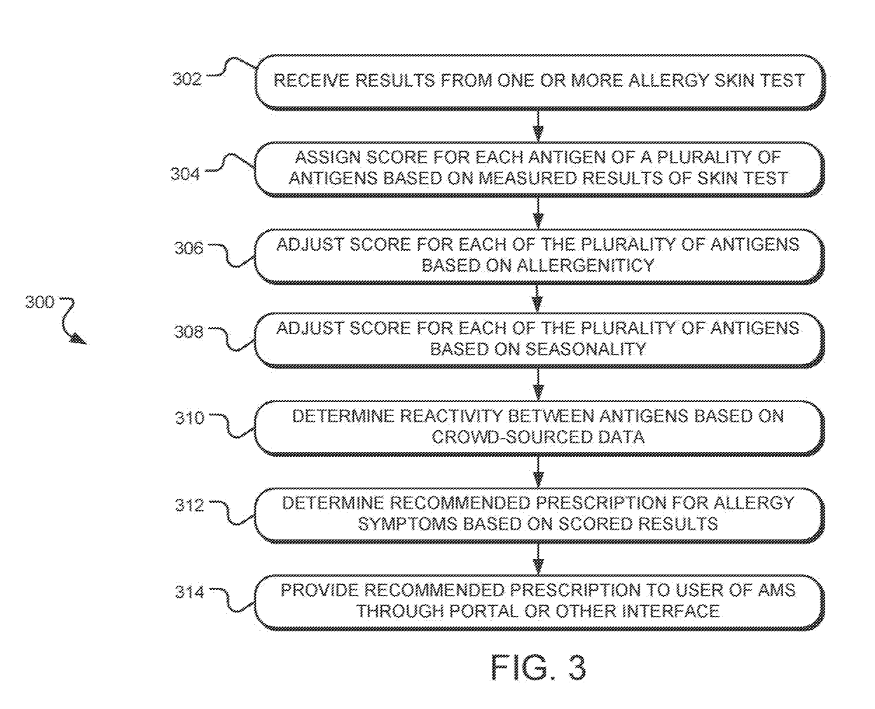

FIG. 3 is a method for providing a medicine recommendation for a patient based on one or more allergy symptoms. In one embodiment, the operations are performed by the AMS 104 executed on the network 102 and/or the computing device 106 executing the portal 107. Further, the operations may be executed through one or more instructions of a software program, one or more circuits or other hardware components of a computing device, or a combination of both software and hardware components of the system.

In operation 302, the AMS 104 receives the results of an allergy skin test. In particular, allergy-test personnel may enter patient demographic information into one or more designated fields within the portal 107 to schedule an allergy test date. At the time of the test, multiple antigens are applied to the patient's skin, perhaps using allergy-skin-prick and/or intradermal test techniques. The antigens tested may include a panel of environmental antigens, such as molds, yeasts, animal dander, plant pollen and dust mites. Allergy-test personnel may then measure the reactions on the patient's skin and record the measurements of allergy skin-prick and intradermal-test wheals into the portal 107 which is transmitted to the AMS 104 for processing.

In one embodiment, the allergy-test personnel may utilize one or more components of the computing device 106 on which the portal 107 is executed to conduct the allergy skin test. For example, the portal 107 may include an application that utilizes the camera in a computing device to photograph or otherwise measure the diameter and height of a skin wheal (welt from skin test) at each skin test site. The device 106 (or any other suitable device) may evaluate either all of the wheals on an area of the skin (e.g., the back) for an entire skin test panel (˜56 test sites), or may measure each individual panel of either 8 or 10 test sites. That measurement is then matched with the respective antigen serum that is applied to the skin test site that produces the wheal. The measured information may be provided to the AMS 104 either automatically by the portal 107 measuring application, or may be entered manually by a user of the computing device 106.

In another example, a 3-D scanner may be used to obtain a three dimensional skin-surface topography image during the skin wheal test. 3-D imaging may be superior to traditional ruler measurements for assessing skin-prick test reactions to histamine and allergens. For high-quality measurements of skin-prick test reactions, 3-D imaging is accurate, consistent and reliable. The 3-D scanner may be incorporated into or otherwise in communication with the computing device 106 and/or the AMS 104. Alternatively, the 3-D scanner may not communicate directly with the computing device 106 and/or the AMS 104. In the latter case, images, topographical information, measurement information, or other information or data may be transferred from the 3-D scanner to the computing device 106 and/or AMS 104 via other means, such as manual entry, memory cards, disks, or the like.

Upon capture by the 3-D scanner, the AMS 104 may integrate the information into the AMS. In some embodiments, the skin-surface topography image may be received and processed to measure skin-prick test results, such as skin wheal length, width, area, fluid content, temperature, oxygenation, and volume, or other reaction measurements, for one or multiple skin wheals. In other embodiments, the scanner or another device may process the skin-surface topography image and provide skin wheal information to the AMS 104. The AMS may convert the skin wheal measurements into numerical data that is populated in a skin-prick test results form. These measurement recordings may be matched with the respective test antigen placed at each skin-prick test site and used, as described in more detail below, in developing a recommended prescription for the patient upon whom the test is conducted.

In another example, an imaging device may be used to capture a skin wheal image (e.g., an image of an area of skin during a skin wheal test). The imaging device may incorporate shortwave infrared, near infrared, infrared, visible light, ultraviolet, thermal, or a combination of such imaging technology. The imaging device may provide an optical image that may be subjected to optical analysis (or other automated or computer-aided or computer performed analysis). Alternatively or additionally, the imaging device may provide other information or data relating to the skin wheal image, such as a measurement, calculation, or estimate of an amount of fluid (e.g., blood, plasma, lymph, extracellular fluid, or the like) present in or under the skin, a temperature of the skin, an oxygenation level of the skin, or any other suitable information or data. Such data (e.g., relating to fluid quantities, temperatures, oxygenation, or the like) may be incorporated into an optical image. For example, regions with a higher fluid content may appear darker than regions with a lower fluid content. Analysis of such an image may include determining a relative darkness and/or size of skin wheals, which may in turn indicate the relative amount of swelling of the skin wheals. The imaging device may provide measurement information to the AMS 104 in order to provide results of a skin-prick test to the AMS 104. The imaging device may be incorporated into or otherwise in communication with the computing device 106 and/or the AMS 104, or it may not be in directed communication with the computing device 106 and/or the AMS 104 (in which case images may be transferred from the imaging device via memory cards, disks, or the like).

In some examples, the imaging device may provide a skin wheal image to the AMS 104 for analysis. The AMS 104 may analyze the received image in order to determine a measurement of the patient reaction to antigens of the skin-prick test. Accordingly, the AMS 104 may determine measurements of skin wheal size, such as length, width, area, fluid content, temperature, oxygenation, and volume, or other reaction measurements after processing an image from the imaging device. In some examples, the imaging device may partially process a captured image (e.g., to produce a higher contrast image), and provide the partially processed image to the AMS 104. In other examples, the imaging device may process a captured image and determine a measurement of the patient reaction, providing to the AMS 104 the measurements associated with antigens of the skin-prick test.

Regardless of how the allergy skin test results are provided, the AMS 104 determines a customized immunotherapy treatment for the patient based on information provided to the AMS 104 and/or stored in the database 110 associated with the AMS. In particular, at operation 304, the AMS 104 identifies relevant antigens by assigning a score and/or rank for each antigen included in the allergy skin test based on the measured results. For example, the AMS 104 may assign a specific-numeric score to each antigen used during the allergy skin test based on the measured skin wheal size for each antigen used in the test. In one example, the test-site-reaction measurement is provided in millimeters and the numeric score for each individual antigen is based on the measured millimeter size of each skin wheal.

In operation 306, the AMS 104 may adjust or scale one or more of the scores associated with each of the plurality of antigens based on the allergenicity of the antigens. For example, the score for each antigen in the skin allergy test may be adjusted or scaled based on the relative severity of the reaction. Thus, antigens that are mildly allergenic (e.g., producing no or having a small wheal size, such as less than about 5 mm) may be given a score of 1; moderately allergenic antigens (e.g., producing a skin wheal between about 5 mm and about 10 mm) may be given a score of 5, while severely allergenic antigens (e.g., producing a skin wheal greater than about 10mm) may be given a score of 10. In general, the score or associated with each antigen may be assigned in any manner based on the allergenicity of the particular antigens used. The relationships between scores and skin wheal sizes noted here are examples, and other correlations or relationships between scores and skin wheal sizes are also contemplated. For example, scores between 1 and 10 may be linearly scaled to measurements from 1 mm to 20 mm. The scaling may not be linear. For example, a score of 1 may be applied to any skin wheal below 5 mm, and scores of 2-10 may be applied to skin wheals ranging from 5 mm to 10 mm. Other scaling techniques and/or mathematical relationships between skin wheal size and scores may also be used.

In operation 308, the AMS 104 may adjust one or more of the scores associated with each of the plurality of antigens based on the seasonality of the antigens. For example, many antigens have a seasonal pattern, meaning they are present in high volumes in certain seasons and are either present in lower levels or completely absent during other seasons. For example, ragweed pollen is prevalent in the summer and early fall months and may completely disappear in late fall. A patient who is highly allergic to ragweed pollen will therefore experience a greater severity of symptoms in the summer and early fall. Thus, the score for each antigen in the skin allergy test may be adjusted based on the seasonality of the antigen. Continuing the above example, the score for ragweed pollen may be adjusted higher during the summer and early fall months, and adjusted lower during the winter. In general, the score associated with any antigen may be adjusted in any manner based on the season in which the recommended prescription is created.

In operation 310, the AMS 104 may further adjust one or more of the scores associated with the antigens based on the reactivity between the antigens included in the test. For example, some antigens may have cross-reactivity with other antigens that may increase or decrease the effect of the antigen in the patient. In one embodiment, this reactivity between two or more antigens may be provided directly to the AMS 104 through the portal 107 and stored by the AMS in the database 110 for use by the AMS. In another embodiment, such information may be observed by the AMS 104 through the information provided for each patient, practitioner, and/or clinic utilizing the AMS such that reactivity between antigens may be determined by the AMS and applied to the scoring of each antigen accordingly.

Once the scores for the plurality of antigens used during the allergy skin test are determined, in operation 312, the AMS 104 may determine and/or calculate a recommended prescription for one or more allergy symptoms of the patient based on the scored results. This prescription may be for drops or shots (or other medicines or treatments), and may include any combination of any number of medicines based on one or more of the scored antigens. Once the recommended prescription is determined, the AMS 104 may provide the recommended prescription to a user of a computing device 106 through the portal 107, or any other type of interface with the AMS in operation 314. For example, a practitioner may utilize the computing device 106 to receive the recommended prescription from the AMS 104 and may generate a script for the recommended prescription, may forward the recommended prescription, and/or may adjust one or more aspects of the prescription. Thus, through the operations of the method 300 of FIG. 3, the AMS 104 may provide a recommendation for a prescription based at least on results from an allergy skin test conducted on the patient.

In some cases, the AMS 104 may produce multiple prescriptions, such as a different prescription for each season. More particularly, because many antigens have a seasonal pattern, a prescription for spring may be different than for winter (as explained above). In order to provide a complete treatment plan, the AMS 104 may produce a different prescription for each season, reflecting the difference in scores due to the adjustment in operation 308 (and/or any other changes to the scores resulting from the seasonality adjustment, such as cross-reactivity scores).

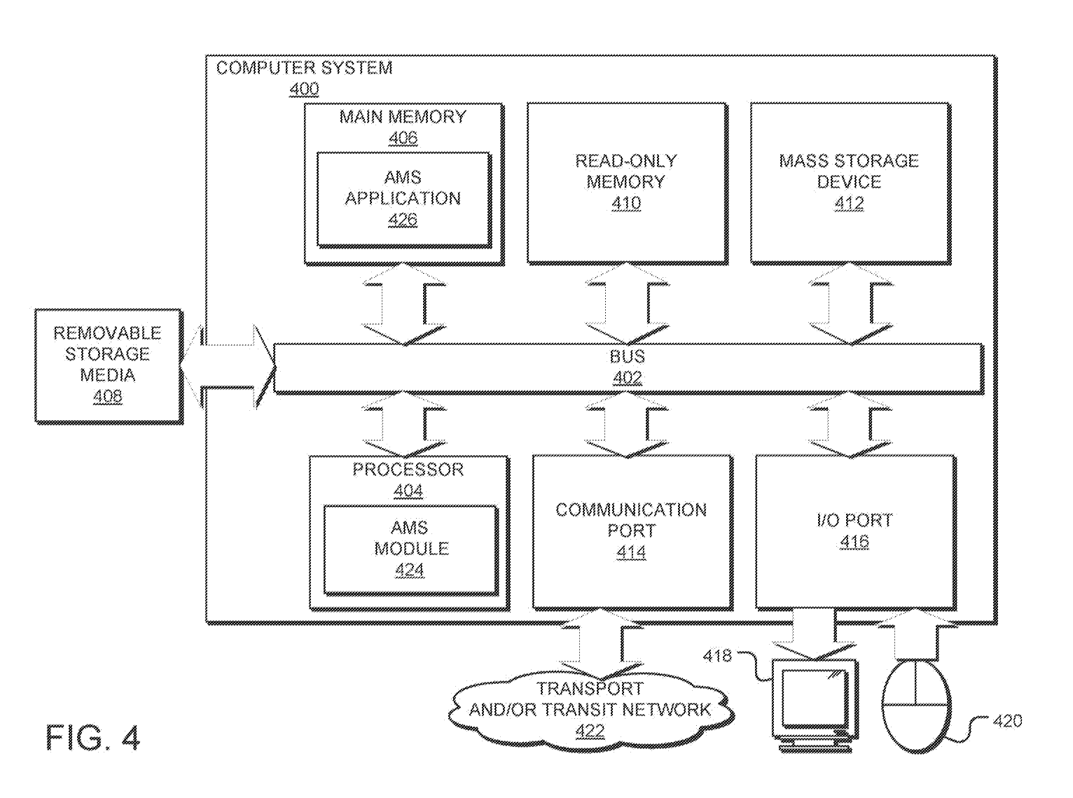

FIG. 4 is an example computing system 400 that may implement various systems and methods discussed herein. The computer system 400 includes one or more computing components in communication via a bus 402. In one implementation, the computing system 400 includes one or more processors 404. The processor 404 may include one or more internal levels of cache memory (not shown) and a bus controller or bus interface unit to direct interaction with the bus 402. The processor 404 may include an AMS module 424 that specifically implements the various methods discussed herein. Main memory 406 may include one or more memory cards and a control circuit (not shown), or other forms of removable memory, and may store an AMS application 426 including computer executable instructions, that when run on the processor 404, implement the methods and systems set out herein. Other forms of memory, such as a removable storage memory 408, a read only memory 410, and a mass storage device 412, may also be included and accessible, by the processor (or processors) 404 via the bus 402.

The computer system 400 may further include a communication port 414 connected to a transport and/or transit network 422 by way of which the computer system 400 may receive network data useful in executing the methods and system set out herein as well as transmitting information and network configuration changes determined thereby. The computer system 400 may include an I/O port 416, or other device, by which information is displayed, such as at display screen 418, or information is input, such as with input device 420. The input device 420 may be alphanumeric input device, including alphanumeric and other keys for communicating information and/or command selections to the processor 404. The input device 420 may be another type of user input device including cursor control, such as a mouse, a trackball, or cursor direction keys for communicating direction information and command selections to the processors 404 and for controlling cursor movement on the display device 418. In the case of a tablet device, the input may be through a touch screen, voice commands, and/or Bluetooth connected keyboard, among other input mechanisms. The system set forth in FIG. 4 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a computer-readable storage medium having stored thereon instructions, which may be used to program a computer system (or other electronic devices) to perform a process according to the present disclosure. A computer-readable storage medium includes any mechanism for storing information in a form (e.g., software, processing application) readable by a computer. The computer-readable storage medium may include, but is not limited to, magnetic storage medium (e.g., floppy diskette), optical storage medium (e.g., CDROM); magneto-optical storage medium, read only memory (ROM); random access memory (RAM); erasable programmable memory (e.g., EPROM and EEPROM); flash memory; or other types of medium suitable for storing electronic instructions.

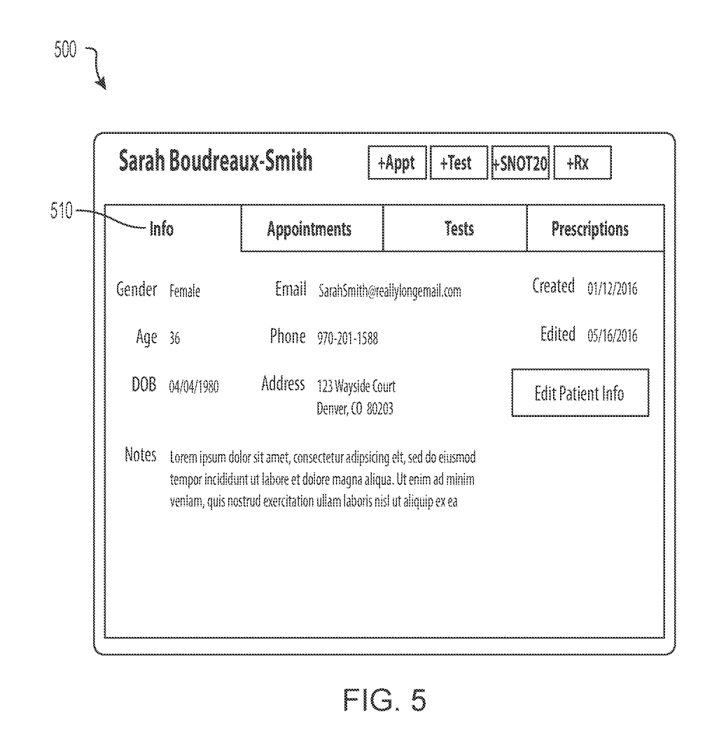

In light of the above, FIGS. 5-8B illustrate example user interfaces of a portal for an allergy management system. For example, the user interfaces included herein may be used in conjunction with the portal 107 that enables a user to access an allergy management system 104 described above.

It should be noted that the user interfaces shown are for illustrative purposes only. In some embodiments, the user interfaces may have various tabs that enable a user to select and/or view different types of information. In some embodiments, the user interfaces may enable a user (e.g., a patient, a physician, an employee, a nurse or other user) to provide input manually. In other embodiments, this information may be automatically populated.

In some embodiments, the tabs included on the user interfaces may include, but are not limited to, a general information tab that provides general information about a user, an appointments tab that shows upcoming appointments of a user, a tests tab that shows the results of past tests taken by a user and/or any upcoming or scheduled tests, and a prescriptions tab that enables a user to view their current prescriptions and/or enables a physician, nurse or other practitioner to review and/or prescribe medication for the user. Additional tabs may also be added. In some embodiments, the tabs may be arranged in any order.

FIG. 5 illustrates a first example user interface 500 that may be used with a portal of an allergy management system. This particular user interface 500 may be shown when a user selects the information tab 510 of a particular user interface. The user interface 500 includes information about a particular patient including, but not limited to, the gender of the patient, the age of the patient, the date of birth of the patient, and contact information about the patient. The contact information may include an email address, a telephone number, an address, and so on.

The user interface 500 may also include any notes about the patient as well as a date or time when the profile of the patient was created and a date the profile was last edited.

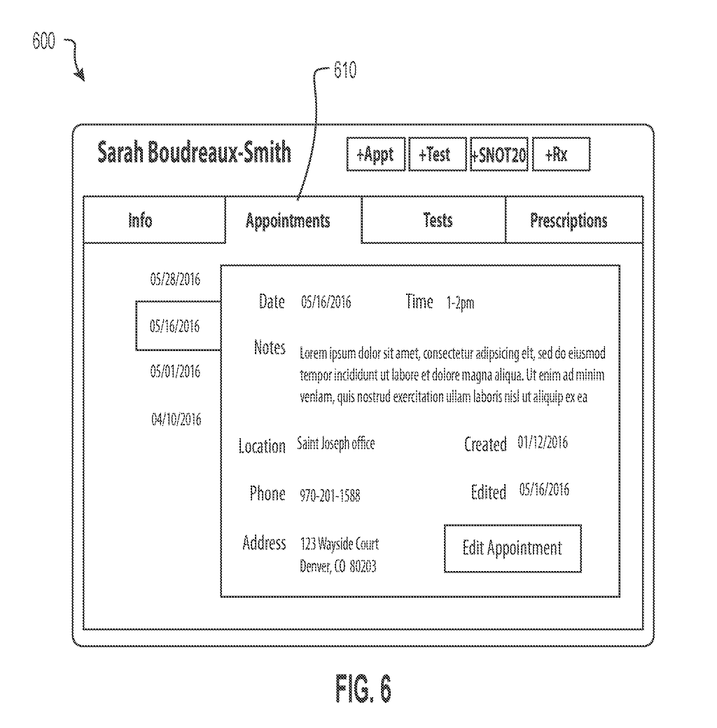

FIG. 6 illustrates another example user interface 600 that may be displayed when a user selects an appointments tab 610 of the user interface 600. The appointments tab 610 may show information about various upcoming appointments of the user. This information may include, but is not limited to, the time of the appointment, the date of the appointment, a location of the appointment, a phone number of the office or physician the user has the appointment with, as well as an address or location of the appointment. The user interface 600 may also include any notes regarding the user and/or the upcoming appointment. The user interface 600 also enables a user to edit information about the appointment.

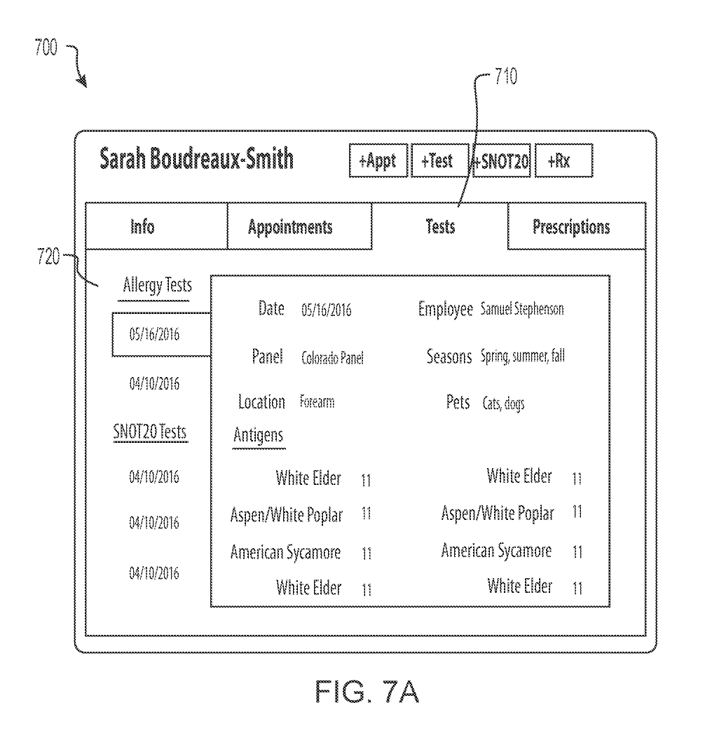

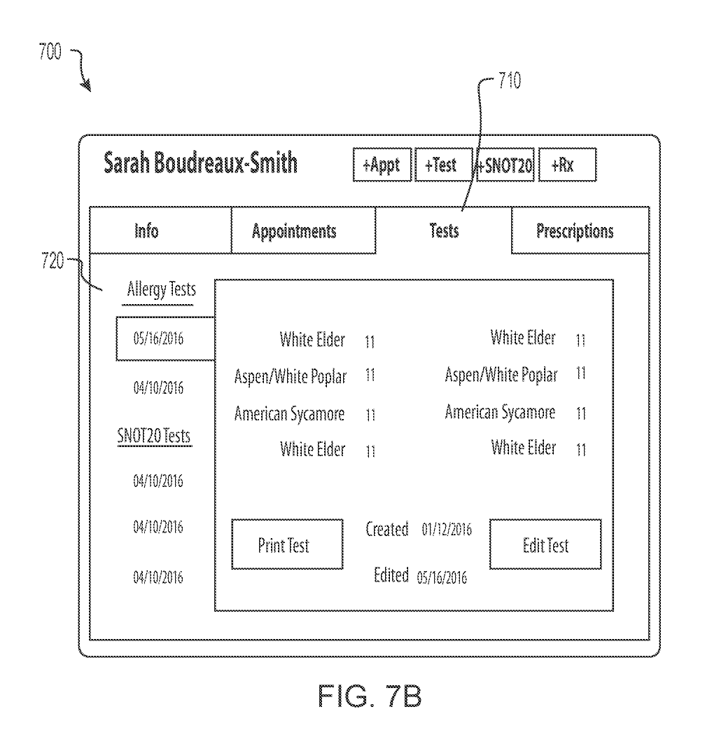

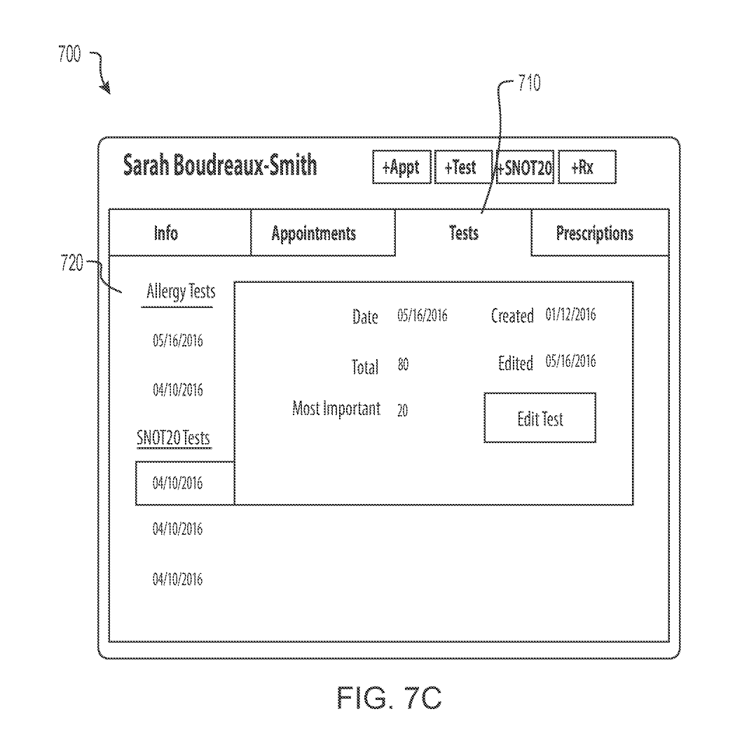

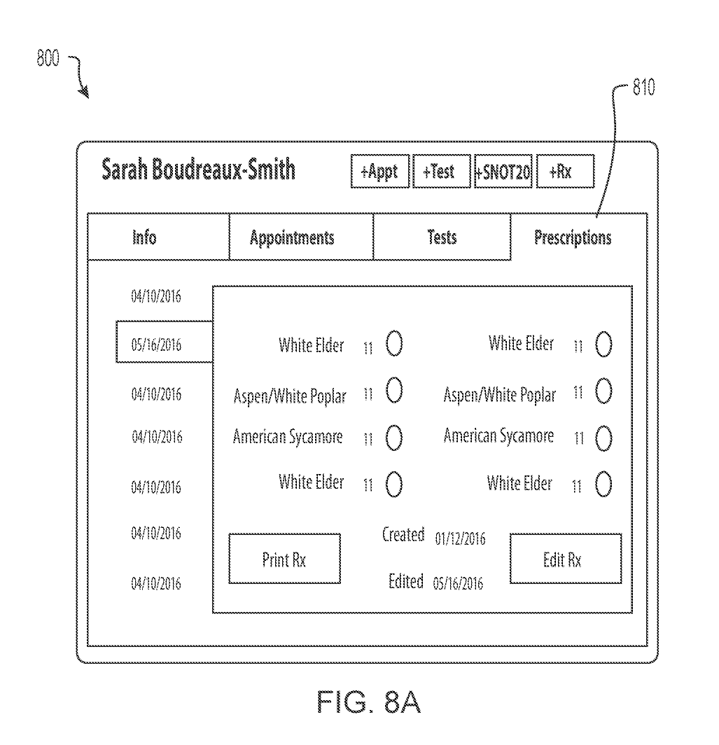

FIGS. 7A-7C illustrates another example user interface 700 that may be presented to a user using the portal described herein. The user interface 700 may be shown in response to a user selecting a test tab 710. In some embodiments, the user interface 700 includes a test selection area 720 that allows a user to select different types of tests for which information is to be displayed. For example, the test selection area 720 enables a user to select between allergy tests and SNOT-20 tests.

In the embodiment shown in FIG. 7A, the allergy tests icon has been selected. In response, the user interface 700 shows information about the particular allergy test that was given on the indicated date (e.g., May 16, 2016). This information includes, but is not limited to, the date of the test, the allergy or regional panel (e.g., Colorado Panel), the location on the body the test was performed on (e.g., forearm), the employee or practitioner giving the test, the seasons during which the symptoms are the most prevalent and whether (and what type) the user had pets in the home.

Each of the items of information may be edited by a user. For example, each item of information may be associated with a dropdown or pull down menu that enables the user to select a particular item from a series of items.

The user interface 700 may also show a list of antigens and an associated score (e.g., allergic reaction score to the particular antigen). In some embodiments, the user interface 700 may enable the user to print or edit the test results such as shown in FIG. 7B.

When the SNOT-20 icon is selected in the test selection area 720, the user interface 700 of FIG. 7C may be output on a display of a computing device. The information that is displayed may include information associated with the SNOT-20 forms described above. In some embodiments, the information may be manually entered by a user or automatically retrieved or otherwise received from another source. Like the other information contained in the various user interfaces described herein, the information contained in the user interface 700 may be editable by a user.

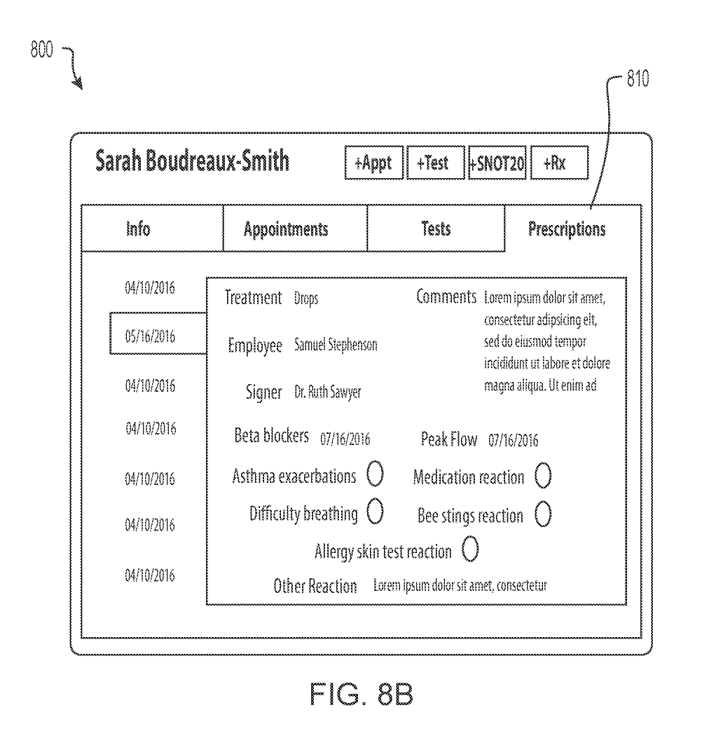

FIGS. 8A and 8B illustrate another example user interface 800 that may be provided by the portal described herein. The user interface 800 may be shown in response to a user selecting the prescriptions tab 810.

In this example, the user interface 800 may enable a user to either select a particular prescription or edit a prescription. In some embodiments, the prescription may be automatically generated based on the antigen scores shown in FIG. 8A.

The user interface may also enable a physician or other practitioner to automatically send the prescription to a pharmacy to be filled. In some embodiments, the prescription is sent to the pharmacy over a data connection, such as, for example, the internet. The user interface may show additional details about the prescription. For example, as shown in FIG. 8B, the information may include the type of treatment (e.g., drops, shots, pills, etc.), the name of the person filling out the prescription form, the signing physician and any comments about the prescription. Other information may be shown as needed including current symptoms the patient is experiencing to certain antigens.

In each of the examples described above, the information contained in the user interface may be automatically or manually populated. For example and as described above, a 3-D scanner or other imaging device may be incorporated into or otherwise in communication with the portal via a computing device and may be used to obtain a skin-surface topography image (or any other suitable image or data) during or after a particular test (e.g., a skin wheal test).

In some embodiments, the portal may be configured to automatically recommend a prescription based on certain skin test results. This recommendation is then automatically provided to a physician for signature. Once the signature is received, the portal may automatically transmit the prescription to a pharmacy or to the selected patient.

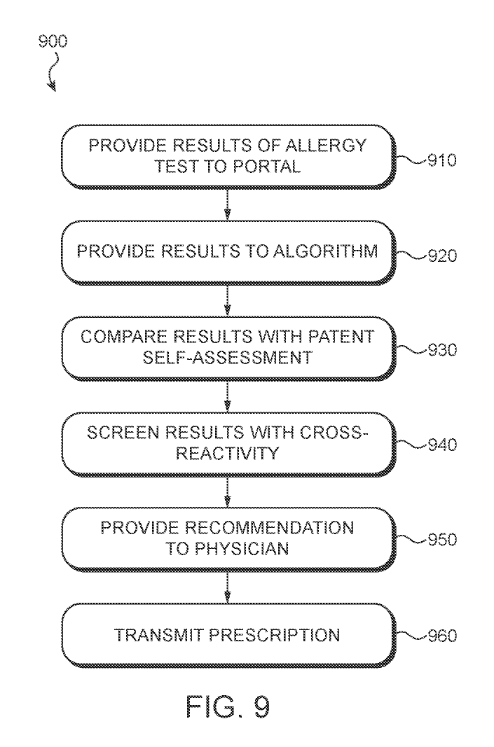

For example and as shown in FIG. 9, the recommendation may proceed when results of a particular allergy test (e.g., an allergy skin prick test (SPT)) performed on a patient are provided 910 to the portal. In some embodiments, a staff member or other user that performs the test may enter the SPT results into the portal. Alternatively, the SPT results can be entered automatically, electronically, via cable-connected or Wi-Fi/Bluetooth transmission from a device that records an image and generates measurement data for each antigen. As noted above, the SPT results may be produced by an automated computer analysis of an image from an imaging device that captures a skin wheal image including data relating to fluid content, temperature, oxygenation, wheal size, wheal volume, wheal density, or the like.

Once the SPT results are entered into the portal, the results are provided 920 to a treatment-recommendation algorithm. In some embodiments, the measurements are combined with the allergenicity score for each antigen and the seasonal presence score of each antigen.

These results may then be compared 930 against a patient's self-reported information. In some embodiments, extra weight may be given to particular antigens based on circumstances associated with the patient. For example, extra weight may be given to pet dander allergies if the patient reports that a pet, to which they are reactive, is living in their primary residence.

Once all of these inputs have been provided, the results (including any weighted score of the antigens) are then screened 940 for cross-reactivity. In this process, the algorithm may select one member from each cross-reactive family, to include in the treatment recommendation. In some cases, the algorithm selects only one member from each cross-reactive family. If the antigens in the same cross-reactive family all are given the same numeric score (e.g., if there is a tie in allergenicity between members of a given cross-reactive family), then a pre-selected antigen representative from that family is selected. For example, if a skin wheal test indicates that a patient is equally allergic to Eastern cottonwood and black willow (as indicated by substantially identical wheal sizes for those antigens), then black willow may be included in the treatment recommendation, as black willow may be a pre-selected representative of the cross-reactive family, and the treatment for black willow may be sufficient to treat the allergy to Eastern cottonwood as well.

In cases where a patient exhibits a greater allergy to a particular antigen in a cross-reactive group, that particular antigen may be included in the treatment recommendation despite it not being the pre-selected representative antigen. For example, if the patient is more allergic to Eastern cottonwood than to black willow (e.g., as indicated by a larger skin wheal for the Eastern cottonwood antigen), the treatment recommendation may include Eastern cottonwood instead of black willow.

Once the treatment recommendation is prepared, it is provided 950 to the prescribing physician. The physician may review the recommendation and make a clinical decision whether or not to accept or modify the antigens to be included in the prescription. Once approved, the prescription may automatically be transmitted 960 to the pharmacy or other institution such as described above.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not meant to be exhaustive or to limit the embodiments to the precise forms disclosed. It will be apparent to one of ordinary skill in the art that many modifications and variations are possible in view of the above teachings. In particular, any features described with respect to one embodiment may also be used in some embodiments, where compatible Likewise, the features of the different embodiments may be exchanged, substituted, or omitted where compatible and appropriate.

What is claimed is:

1. A system for providing allergy-related care, comprising:
a database;
a user computing device;
an imaging device configured to capture a skin wheal image;
a network device executing an allergy management application, the allergy management application configured to:
receive patient-related information from a user of the user computing device, via a portal executed on the user computing device;
store the patient-related information from the user in the database;
receive the skin wheal image;
identify an antigen based on the skin wheal image and the patient-related information;
determine a prescription recommendation based on the identified antigen; and
provide the prescription recommendation to the user computing device via the portal.

2. The system of claim 1, wherein the allergy management application is further configured to:
identify a plurality of antigens based on the skin wheal image and the patient-related information;
rank the plurality of antigens from most relevant to least relevant based on at least one of an allergenicity score and a seasonality of the antigens.

3. The system of claim 2, wherein:
the allergy management application is further configured to analyze the skin wheal image; and
the allergenicity score is based on the analysis of the skin wheal image.

4. The system of claim 2, wherein the seasonality of the antigens is based on the patient-related information.

5. The system of claim 2, wherein the allergy management application is further configured to analyze the plurality of antigens for cross-reactivity.

6. The system of claim 2, wherein in response to a determination that two or more of the plurality of antigens are cross-reactive, a preferred antigen is selected as representative of the two or more antigens.

7. A method for providing allergy-related care, comprising:
receiving patient-related information from a user computing device;
analyzing the patient-related information to determine an environmental antigen;
storing the patient-related information in a database;
calculating a prescription recommendation based on the determined environmental antigen; and
providing the calculated prescription recommendation to the user computing device.

8. The method of claim 7, further comprising:
receiving skin wheal measurement information from an imaging device; and
determining the environmental antigen based on the skin wheal measurement information and the patient-related information.

9. The method of claim 7, further comprising:
receiving confirmation of the prescription recommendation from the user computing device; and
transmitting a prescription to an external system.

10. The method of claim 7, further comprising:
analyzing the patient-related information to determine a plurality of environmental antigens; and
assigning an allergenicity score to the plurality of environmental antigens.

11. The method of claim 10, further comprising:
ranking the plurality of environmental antigens based on the allergenicity score and a seasonality of each of the plurality of environmental antigens; and
calculating the prescription recommendation based on the ranking of the plurality of environmental antigens.

12. The method of claim 8, wherein:
the skin wheal measurement information comprises a skin wheal image; and
the method further comprises analyzing the skin wheal image to determine an allergenicity score of the environmental antigen.

13. The method of claim 8, further comprising:
analyzing the patient-related information and the skin wheal measurement information to determine a plurality of environmental allergens;
analyzing the plurality of environmental antigens for cross-reactivity; and
calculating the prescription recommendation based on the cross-reactivity of the environmental antigens.

14. An electronic device for providing allergy-related care, comprising:
a network interface configured to communicate with a database and a portal device;
a processor coupled to the network interface and configured to:
receive patient-related information from the portal device;
identify an antigen based on the patient-related information;
store the patient-related information from the portal device in the database;
calculate a prescription recommendation based on the identified antigen;
transmit the calculated prescription recommendation to the portal device; and
receive an approval of the prescription recommendation from the portal device.

15. The electronic device of claim 14 wherein the electronic device comprises a scanner and the processor is further configured to:
receive measurement information from the scanner; and
calculate the prescription recommendation further based on the received measurement information.

16. The electronic device of claim 15, wherein the measurement information comprises a three dimensional topography map and the processor is further configured to:
determine at least one of a length, a width, or an area of a skin wheal based on the three dimensional topography map; and
determine an allergenicity score of the antigen based on the at least one of the length, the width, or the area of the skin wheal.

17. The electronic device of claim 16, wherein the processor is further configured to:
determine the allergenicity score of each of a plurality of antigens based on the three dimensional topography map; and
analyze the plurality of antigens for cross-reactivity.

18. The electronic device of claim 17, wherein in response to a determination that two or more of the plurality of antigens are cross-reactive, the prescription recommendation is based on a representative antigen of the two or more antigens.

19. The electronic device of claim 15, wherein the processor is further configured to:
identify a plurality of antigens based on the measurement information and the patient-related information; and
assign an allergenicity score to at least a first of the plurality of antigens based on the measurement information.

20. The electronic device of claim 19, wherein the processor is further configured to:
determine a seasonality of at least the first of the plurality of antigens based on the patient-related information; and
rank the plurality of antigens based on the allergenicity score and the seasonality of the plurality of antigens.
